(19) United States
(12) Patent Application Publication
(10) Pub. No.: US 2026/0051424 A1
(43) Pub. Date: Feb. 19, 2026

(54) METHOD FOR PRODUCING A BI- OR MULTIPOLAR LEAD

(71) Applicant: Heraeus Medevio GmbH & Co. KG, Hanau (DE)

(72) Inventors: Leoni WILHELM, Hanau (DE); Markus JUNG, Hanau (DE)

(21) Appl. No.: 19/300,189

(22) Filed: Aug. 14, 2025

(30) Foreign Application Priority Data
Aug. 19, 2024 (DE) 102024123568.3

(51) Int. Cl. H01B 13/00; H01B 7/00

(52) U.S. Cl. CPC H01B 13/0016; H01B 7/009

(57) ABSTRACT

A method for producing a multipolar lead comprising the steps of: providing a hollow-cylindrical inner lining having an inner lining length which corresponds to a multiple of a lead length of the lead for the medical device; providing a plurality of electrically conductive channels, wherein each of the channels is formed by at least one insulated conductor comprising an electrical conductor and an insulating layer; spirally winding the insulated conductors around the inner lining; cutting the uninsulated cable to a length which corresponds to the lead length; sheathing the uninsulated lead cable with a shrink tube; heating the shrink tube to provide an insulated lead cable; providing a plurality of electrodes; creating a plurality of contact openings near a distal end of the lead cable; and, electrically contacting the plurality of electrodes, wherein each electrode is selectively connected to at least one electrically conductive channel via contact openings.

### CROSS-REFERENCE TO RELATED APPLICATION

This application claims priority pursuant to 35 U.S.C. 119(a) to German Patent Office Application No. 102024123568.3, filed Aug. 19, 2024, which application is incorporated herein by reference in its entirety.

### BACKGROUND

The invention relates to a method for producing a bi- or multipolar lead for a medical device, comprising the method steps of:
a) providing a hollow-cylindrical inner lining having an inner lining length which corresponds to a multiple of a lead length of the lead for the medical device;
b) providing a plurality of electrically conductive channels, wherein each of the channels is formed by at least one insulated conductor comprising an electrical conductor and an insulating layer;
c) spirally winding the insulated conductors around the inner lining to provide an uninsulated cable having a cable length which corresponds to a multiple of the lead length;
d) cutting the uninsulated cable to a length which corresponds to the lead length, to provide an uninsulated lead cable;
e) sheathing the uninsulated lead cable with a shrink tube;
f) heating the shrink tube to provide an insulated lead cable having the shrunk shrink tube as an outer insulation;
g) providing a plurality of electrodes;
h) creating a plurality of contact openings near a distal end of the lead cable, wherein, in order to create a contact opening, parts of the outer insulation and parts of the insulating layer of at least one of the electrically conductive channels are removed so that the at least one electrically conductive channel can be selectively contacted via each of the contact openings;
i) electrically contacting the plurality of electrodes with the plurality of electrically conductive channels via the plurality of contact openings, wherein each of the electrodes is selectively electrically connected to at least one of the electrically conductive channels via one of the contact openings.

The bi- or multipolar lead is suitable for a medical device and, in one embodiment, for a temporary measuring lead. However, the bi- or multipolar lead can also be used in other technical areas.

Bi- or multipolar leads, and especially multipolar leads, for medical devices are usually very complex to produce since their production requires a large number of different components which must be assembled in a multitude of individual steps. The production of small-format leads, which are particularly in demand in the field of medical devices, is even more complex. The complex design of bi- or multipolar leads and especially their production usually lead to high prices for the final product.

The high prices of known bi- or multipolar leads are particularly problematic when the leads are to be used in medical devices for a relatively short period of time, e.g., in a temporary device for medical tests. In order to conduct temporary medical tests in an economically viable manner, cheaper unipolar leads are therefore chosen for the tests. However, the use of a unipolar lead may limit the success of the test, which may result in fewer patients receiving appropriate medical treatment in the form of a permanent medical device.

In addition, a bi- or multipolar lead designed and produced using a large number of individual components may demonstrate lower reliability because there are more possible failure modes of the individual parts. Thus, lower reliability may lead to a higher risk of failure of the lead, which in turn may have significant consequences, such as for a patient's health, if the lead is used in a medical device.

In view of the above, it is desirable to provide a method for producing a bi- or multipolar lead which is simple, reliable, flexible and efficient to carry out.

### OBJECTS

One object of the present invention is to overcome, at least in part, one or more of the disadvantages resulting from the prior art.

It is a further object of the invention to provide a method for producing a bi- or multipolar lead which is as simple, reliable, flexible and cost-effective as possible.

### Preferred Embodiments of the Invention

A contribution to the at least partial fulfillment of at least one of the aforementioned objects is made by the features of the independent claims. The dependent claims provide preferred embodiments that contribute to the at least partial fulfillment of at least one of the objects.

A first embodiment of the invention is a method for producing a bi- or multipolar lead for a medical device comprising the method steps of:
a) providing a hollow-cylindrical inner lining having an inner lining length which corresponds to a multiple of a lead length of the lead for the medical device;
b) providing a plurality of electrically conductive channels, wherein each of the channels is formed by at least one insulated conductor comprising an electrical conductor and an insulating layer;
c) spirally winding the insulated conductors around the inner lining to provide an uninsulated cable having a cable length which corresponds to a multiple of the lead length;
d) cutting the uninsulated cable to a length which corresponds to the lead length, to provide an uninsulated lead cable;
e) sheathing the uninsulated lead cable with a shrink tube;
f) heating the shrink tube to provide an insulated lead cable having the shrunk shrink tube as an outer insulation;
g) providing a plurality of electrodes;
h) creating a plurality of contact openings near a distal end of the lead cable, wherein, in order to create a contact opening, parts of the outer insulation and parts of the insulating layer of at least one of the electrically conductive channels are removed so that the at least one electrically conductive channel can be selectively contacted via each of the contact openings;
i) electrically contacting the plurality of electrodes with the plurality of electrically conductive channels via the plurality of contact openings, wherein each of the electrodes is selectively electrically connected to at least one of the electrically conductive channels via one of the contact openings.

In a preferred embodiment of the method, the hollow-cylindrical inner lining comprises a polymer hose, a metal tube and/or a metal braid or consists of a polymer hose, a metal tube or a metal braid. This embodiment is a second embodiment of the invention, which is preferably dependent upon the first embodiment of the invention.

In a preferred embodiment of the method, the provision in method step a) comprises pulling the inner lining onto a mandrel. This embodiment is a third embodiment of the invention, which is preferably dependent upon the first or second embodiment of the invention.

In a preferred embodiment of the method, the shrink tube comprises an elastomer or the shrink tube consists of an elastomer. This embodiment is a fourth embodiment of the invention, which is preferably dependent upon any of the previous embodiments of the invention.

In a preferred embodiment of the method, the shrink tube comprises a fluorinated polymer or consists of a fluorinated polymer. This embodiment is a fifth embodiment of the invention, which is preferably dependent upon any of the previous embodiments of the invention.

In a preferred embodiment of the method, the fluorinated polymer is an ethylene-tetrafluoroethylene copolymer (ETFE), a polytetrafluoroethylene (PTFE), a perfluoroalkoxy polymer (PFA), a polyvinylidene fluoride (PVDF) and/or a tetrafluoroethylene-hexafluoropropylene copolymer (FEP). This embodiment is a sixth embodiment of the invention, which is preferably dependent upon the fifth embodiment of the invention.

In a preferred embodiment of the method, the heating in method step f) takes place to a temperature range between 140° C. and 220° C. This embodiment is a seventh embodiment of the invention, which is preferably dependent upon any of the previous embodiments of the invention. In a preferred embodiment of the method, the inner lining length in method step a) is in a range between 50 m and 2,000 m. This embodiment is an eighth embodiment of the invention, which is preferably dependent upon any of the previous embodiments of the invention.

In a preferred embodiment of the method, the electrical contacting in method step i) takes place via a bridge element. This embodiment is a ninth embodiment of the invention, which is preferably dependent upon any of the previous embodiments of the invention.

In a preferred embodiment of the method, the shrink tube in method step e) has a thickness in a range of 50 μm to 350 μm. This embodiment is a tenth embodiment of the invention, which is preferably dependent upon any of the previous embodiments of the invention.

In a preferred embodiment of the method, the shrink tube in method step e) has a length which corresponds to 1.01 to 1.1 times the lead length. This embodiment is an eleventh embodiment of the invention, which is preferably dependent upon any of the previous embodiments of the invention.

In a preferred embodiment of the method, the shrink tube in method step e) has an inner diameter which corresponds to 1.01 to 1.1 times the outer diameter of the uninsulated lead cable. This embodiment is a twelfth embodiment of the invention, which is preferably dependent upon any of the previous embodiments of the invention.

### General

In addition to the embodiments described herein, the elements of which “contain” or “comprise” a particular feature (e.g., a material), a further embodiment is always contemplated in which the element in question consists solely of the feature, i.e., does not comprise any other components. The word “comprise” or “comprising” is herein used synonymously with the word “contain”or “containing”.

When in an embodiment an element is referred to in the singular, an embodiment is also contemplated in which several of these elements are present. The use of a term for an element in the plural generally also includes an embodiment in which only a single corresponding element is included.

Unless otherwise stated or clearly excluded from the context, it is fundamentally possible and is hereby clearly considered that features of different embodiments can also be provided in the other embodiments described herein. It is also generally contemplated that all features described herein in connection with a method are also applicable to the products and devices described herein, and vice versa.

Merely for the sake of conciseness, these considered combinations are not all explicitly listed in all cases. Technical solutions that are known to be equivalent to the features described herein should also be included in principle in the scope of the invention.

In the present description, specifications of ranges also contain the values specified as limits. A specification of the type “in the range from X to Y” with respect to a quantity A consequently means that A can take the values X, Y and values between X and Y. Ranges which are limited on one side of the type “up to Y” for a size A, accordingly mean a value Y and less than Y.

Some of the features described are associated with the term “substantially”. The term “substantially” is to be understood in such a way that, under real conditions and manufacturing techniques, a mathematically exact interpretation of terms such as “superimposition”, “perpendicular”, “diameter” or “parallelism” can never be given exactly, but only within certain manufacturing error tolerances. For example, “substantially perpendicular axes” enclose an angle of 85 degrees to 95 degrees relative to one another, and “substantially equal volumes” comprise a variation of up to 5% by volume. For example, a “device consisting substantially of plastics” comprises a plastics content of ≥95 to ≤100% by weight. For example, a “substantially complete filling of a volume B” comprises a filling of ≥95 to ≤100% by volume of the total volume of B. When an indefinite or definite article is used when referring to a singular noun, such as “a”, “an” or “the”, it includes a plural of that noun unless explicitly stated otherwise. When the term “comprising” is used in the present description and claims, other elements are not thereby excluded.

For the purposes of the present invention, the terms “consisting substantially of” and “consisting of” are considered embodiments of the term “comprising”. When a group is defined below as comprising at least a certain number of embodiments, this is also to be understood as disclosing a group which, in one embodiment, consists substantially only of these embodiments or, in one embodiment, consists only of these embodiments.

Terms such as “obtainable” or “definable” and “obtained” or “defined” are used interchangeably. This means, for example, that the term “obtained” does not imply that an embodiment must be obtained, for example, by the sequence of steps following the term “obtained”, unless the context clearly dictates otherwise, although such a limited understanding is always included in the terms “obtained” or “defined” as an embodiment. Whenever the terms “including” or “with” are used, these terms are synonymous with “comprising” as defined above.

### SUMMARY

A first object of the invention relates to a method for producing a bi- or multipolar lead for a medical device, comprising the method steps of:
a) providing a hollow-cylindrical inner lining having an inner lining length which corresponds to a multiple of a lead length of the lead for the medical device;
b) providing a plurality of electrically conductive channels, wherein each of the channels is formed by at least one insulated conductor comprising an electrical conductor and an insulating layer;
c) spirally winding the electrically conductive channels around the inner lining to provide an uninsulated cable having a cable length which corresponds to a multiple of the lead length;
d) cutting the uninsulated cable to a length which corresponds to the lead length, to provide an uninsulated lead cable;
e) sheathing the uninsulated lead cable with a shrink tube;
f) heating the shrink tube to provide an insulated lead cable having the shrunk shrink tube as an outer insulation;
g) providing a plurality of electrodes;
h) creating a plurality of contact openings near a distal end of the lead cable, wherein, in order to create a contact opening, parts of the outer insulation and parts, in particular radially outer parts, of the insulating layer of at least one of the electrically conductive channels are removed so that the at least one electrically conductive channel can be selectively contacted via each of the contact openings;
i) electrically contacting the plurality of electrodes with the plurality of electrically conductive channels via the plurality of contact openings, wherein each of the electrodes is selectively electrically connected to at least one of the electrically conductive channels via one of the contact openings.

The method serves to produce a bi- or multipolar lead for a medical device in a simple and efficient manner, wherein the method also makes a large number of different leads, in particular leads of different lengths and/or provided with a different number of electrodes, easily and efficiently accessible due to its high flexibility. In addition, the method is suitable for a wide variety of different materials, such as different metals, for example for use in electrically conductive channels, or for different insulators for use in outer insulation. The method also enables electrical contact of the electrodes, particularly in the form of ring electrodes, at any point of the insulated lead cable. Due to the efficient implementation of the method, leads can also be produced for temporary applications, such as temporary medical measuring arrangements, which would not be attractive from an economic perspective using other methods.

A “bipolar” lead within the meaning of the invention is understood to mean a lead comprising two conductive channels and two electrodes which are each electrically connected to one of the conductive channels near the distal end of the lead cable. A “multipolar” lead within the meaning of the invention is understood to mean a lead comprising at least three conductive channels and three electrodes which are each electrically connected to one of the conductive channels near the distal end of the lead cable. In general, the polarity of the lead is determined by the number of conductive channels in the lead. Since each of the conductive channels is selectively connected to an electrode near the distal end of the lead cable, the number of electrodes also determines the minimum number of electrically conductive channels near the distal end of the lead cable. Thus, a multipolar lead comprising four electrodes comprises a minimum of four electrically conductive channels.

“Near the distal end” of the lead cable means that a position lies within the last 30%, preferably the last 20%, most preferably the last 10% of the lead cable length, and “near the proximal end” means that a position lies within the first 30%, preferably the first 20%, most preferably the first 10% of the lead cable length.

An “electrically conductive channel” within the meaning of the invention is a means for selectively electrically connecting an electrical part (e.g., a ring electrode) near the proximal end of the lead to an electrode, preferably a ring electrode, near the distal end of the lead.

In method step a), a hollow-cylindrical, i.e., in the broadest sense hose-or tube-shaped, inner lining is provided. The inner lining defines an inner lumen, i.e., a free space in the middle of the lead, which extends axially through the lead to be manufactured. The inner lumen represents a cavity in the lead to be manufactured into which further devices such as guide wires can be introduced and/or through which further devices can be introduced through the lead into a patient's body. The inner lining serves as a support structure for the lead and can give it improved stability.

The inner lining can, for example, comprise or consist of a hollow cylinder, for example made of a polymer, a thread, for example made of a metal, and/or a braid, for example made of a metal.

The inner lining has an inner lining length which is a multiple of, for example five to two hundred times, the length of the lead to be manufactured. Such a long inner lining is therefore suitable to produce a large number of leads. This simplifies the production process and also allows leads of different lengths to be produced from the same starting material, which makes the production process flexible.

The inner lining preferably comprises an outer diameter in a range of 50 μm to 500 μm, in one embodiment in a range of 200 μm to 400 μm, and a wall thickness in a range of 10 μm to 100 μm and in one embodiment of 20 μm to 80 μm.

In method step b), a plurality of electrical channels are provided, for example from two to thirty, preferably from four to twenty, most preferably from six to fourteen. Each of the channels comprises at least one insulated conductor comprising an electrical conductor and an insulating layer. The insulating layer serves to electrically isolate the electrically conductive channel from another electrically conductive channel.

The electrical conductor of the at least one insulated conductor may be a single conductor or a plurality of individual conductors. Preferably, the conductor is a metal wire or a plurality of metal wires, wherein the plurality of metal wires is preferably wound or rolled into a bundle of metal wires. The metal wire or the metal wire bundle may have a diameter in a range of 5 to 250 μm, preferably in a range of 10 to 120 μm. For example, the conductor (e.g., the metal wire or the metal wire bundle) may have a diameter of about 85 μm.

The electrical conductor preferably consists of a metal selected from the group that consists of platinum, iridium, tantalum, palladium, titanium, iron, gold, molybdenum, niobium, tungsten, nickel, chromium, cobalt, stainless steel, nitinol, alloys of any of these metals and composite materials, of any of these metals. Stainless steel such as stainless steel AISI 316L, stainless steel AISI 301 or stainless steel AISI 304 is suitable as an electrical conductor. Platinum and platinum alloys such as Pt/Ir 10 or Pt/Ir 20 are suitable as electrical conductors. Nickel-cobalt alloys such as MP35N are suitable as electrical conductors.

The electrical conductor can also be provided with a coating (e.g., platinum) or plated to increase corrosion resistance. The electrical conductor can be, for example, a Pt-coated MP35N conductor or a Pt-coated tungsten-based conductor.

The insulating layer is preferably made of a polymer selected from the group consisting of polyolefins (e.g., polyethylene), polyurethanes, polyimides, polyamides, polyaryletherketone (e.g., polyetheretherketone), fluorinated polymers (e.g., selected from the group of ethylenetetrafluoroethylene, polytetrafluoroethylene, perfluoroalkoxyalkanes, polyvinylidene fluorides, fluorinated ethylenepropylene and mixtures thereof) and mixtures thereof.

In method step c), the electrically conductive channels are spirally wound around the inner lining to provide an uninsulated cable. Due to the winding, the inner lining is preferably coaxially surrounded by the electrically conductive channels. The uninsulated cable provided in this way has a cable length which corresponds to a multiple of the lead length; in particular, the length of the uninsulated cable substantially corresponds to the inner lining length of the inner lining provided in method step a). Preferably, the electrically conductive channels are wound spirally around the inner lining, lying next to one another. More preferably, the electrically conductive channels in the wound state extend substantially from a proximal inner lining end to a distal inner lining length of the inner lining.

The advantage of spiral winding is that it can achieve improved stability and flexibility of the lead.

In method step d), the uninsulated cable is cut to a length which substantially corresponds to the lead length, to provide an uninsulated lead cable. The cutting also allows a plurality of uninsulated lead cables to be provided from a single uninsulated cable. The desired length of the lead is determined by the cutting. The uninsulated cable can be cut into pieces of equal length so that the lead length of each of the final leads is the same, or the uninsulated cable can be cut into different lead lengths so that leads of different lengths can be produced from the uninsulated cable.

The cutting thus increases the flexibility of the method which can also be carried out cost-effectively.

The cutting can be carried out in different ways. For example, the cutting can be done using pliers, scissors or using a wire cutting machine. Furthermore, the cutting can be carried out using a laser, for example.

In method step e), the previously cut uninsulated lead cable is sheathed with a shrink tube. A shrink tube is a preferably flexible tube made of a thermoplastic material which contracts radially when heated and thus wraps itself around the object to be wrapped, in this case the uninsulated lead cable, creating a preferably permanent, abrasion-resistant, waterproof and electrically insulating barrier.

By sheathing, the uninsulated lead cable is coaxially surrounded by the shrink tube.

The shrink tube can be made of different materials or material combinations.

In method step f), the shrink tube is heated so that it contracts radially and fits snugly against the uninsulated lead cable. Due to the heating and the resulting contraction of the shrink tube, the contracted shrink tube acts as an outer insulation, in particular outer electrical insulation, of the previously uninsulated lead cable, forming a now insulated, in particular electrically insulated, lead cable.

In method step g), a plurality of electrodes are provided for the lead. The exact number of electrodes depends on the use of the lead. Preferably, a maximum of as many electrodes as electrically conductive channels are provided so that each of the electrodes can be electrically connected to an electrically conductive channel during the method. More preferably, the number of electrodes is half the number of electrically conductive channels provided so that over the course of the method, each of the electrodes can be electrically connected to two electrically conductive channels. In this way, each electrode comprises a second electrically conductive channel as a backup system in case the first electrically conductive channel fails.

Preferably, the electrodes are ring electrodes.

The electrodes can comprise a plurality of different materials or consist of different materials. Preferably, the electrodes comprise a metal that is selected from the group consisting of platinum, iridium, tantalum, palladium, titanium, iron, gold, molybdenum, niobium, tungsten, nickel, chromium, cobalt, steel, nitinol, alloys of any of these metals, and composites of any of these metals. Stainless steel is suitable as an electrode, for example stainless steel AISI 316L, stainless steel AISI 301 or stainless steel AISI 304. Platinum and platinum alloys such as Pt/Ir 10 or Pt/Ir 20 or nickel-cobalt alloys such as MP35N are also suitable as electrodes.

The choice of metal for the electrodes (and for the electrical conductors) may depend on the use of the lead according to the invention. For example, if the lead according to the invention is to be used in a permanent medical device, the electrodes may comprise, or in one embodiment consist of, platinum or a platinum-iridium alloy. If the lead according to the invention is to be used in a temporary medical device, the electrodes may comprise, and in one embodiment consist of, stainless steel. However, the application of the lead is not limited by the use of a particular metal.

The electrodes may also have a coating. Suitable coatings are metal nitrides such as TiN, metal oxides such as IrO₂ or conductive polymers. The surface of the electrodes can also be surface-structured, e.g., laser-structured.

Each of the electrodes, preferably ring electrodes, can have an outer diameter in the range of 200 to 5000 μm, in one embodiment in the range of 300 to 3000 μm and in one embodiment in the range of 500 to 1500 μm. Each of the electrodes may have a wall thickness in the range of 10 to 200 μm, in one embodiment 10 to 100 μm, and in one embodiment 30 to 70 μm. Furthermore, each of the electrodes may have a length in the range of 200 to 5000 μm, in one embodiment 300 to 3000 μm, and in one embodiment in the range of 500 to 1500 μm. According to one embodiment, each of the electrodes has an outer diameter in the range of 300 to 3000 μm and in one embodiment in the range of 500 to 1500 μm, a wall thickness in the range of 10 to 100 μm and in one embodiment of 30 to 70 μm, and a length in the range of 300 to 3000 μm and in one embodiment in the range of 500 to 1500 μm.

In method step h), a plurality of contact openings, preferably the same number as the provided electrodes, are created near the distal end of the insulated lead cable. For this purpose, a part of the outer insulation, i.e., a part of the shrunk shrink tube, as well as a part of the insulating layer of at least one of the electrically conductive channels running there is removed at the corresponding locations, so that at least one electrical conductor of an electrically conductive channel is accessible from the outside and can be electrically contacted at each of the contact openings. Preferably, only a radially outer part of the insulating layer of the electrical conductor is removed. At each of the contact openings, one of the provided electrodes can thus be electrically connected to at least one of the electrically conductive channels over the further course of the method. In one embodiment, parts of the insulating layer of two electrically conductive channels are removed at the contact openings so that one of the electrodes can be selectively electrically connected to two electrically conductive channels via these contact openings.

The contact opening can be created in different ways. For example, the contact opening can be created by cutting, punching or, preferably, by laser ablation.

In method step i), the plurality of electrodes are electrically contacted with the plurality of electrically conductive channels via the plurality of contact openings. Each of the electrodes is selectively, i.e., specifically, electrically connected to at least one of the electrically conductive channels via one of the contact openings.

The electrical contacting can be carried out in different ways. For example, a direct electrical contact can be created between the electrode and the electrically conductive channel by bringing both parts into direct electrical contact. Furthermore, indirect electrical contact can be created by electrically connecting the electrode and the electrically conductive channel via an electrically conductive bridge element, i.e., a separate, electrically conductive component, such as a wire or a wire portion, comprising an electrically conductive material such as a metal or an electrically conductive polymer. The bridge element serves in particular to bridge the distance between the electrically conductive channel(s), in particular their electrical conductors, and the electrode to be contacted, which is caused in particular by the radial thickness of the outer insulation.

For example, the electrodes are ring electrodes which are pressed onto the electrical conductor of the electrically conductive channel by external force in order to establish an electrical contact, directly or indirectly.

Furthermore, in order to securely connect the electrode to the electrically conductive channel, a fastening such as a weld, preferably by means of laser action, can be formed between the electrode and the electrically conductive channel.

The inner lining can be made of different materials or combinations of materials and have different structures.

A preferred embodiment of the method is characterized in that the hollow-cylindrical inner lining comprises a polymer hose, a metal tube, a metal braid or a combination of the above or consists of a polymer hose, a metal tube or a metal braid.

Preferably, the polymer of the inner lining in the form of a polymer tube is selected from the group consisting of silicones, polyolefins (e.g., polyethylene), polyurethanes, polyimides, polyamides, polyaryletherketone (e.g., polyetheretherketone), fluorinated polymers (e.g., selected from the group of ethylenetetrafluoroethylene, polytetrafluoroethylene, perfluoroalkoxyalkanes, polyvinylidene fluorides, fluorinated ethylenepropylene, and mixtures thereof), and mixtures thereof.

Preferably, the metal of the inner lining in the form of a metal tube or metal braid is selected from the group consisting of platinum, iridium, tantalum, palladium, titanium, iron, gold, molybdenum, niobium, tungsten, nickel, chromium, cobalt, stainless steel, nitinol, alloys of any of these metals, and composites of any of these metals.

A preferred embodiment of the method is characterized in that the provision in method step a) comprises pulling the inner lining onto a mandrel. The mandrel preferably fills the inner lumen of the inner lining substantially completely and thus gives the inner lining stability for the subsequent method steps. Suitable structures and materials for suitable mandrels are familiar to a person skilled in the art.

The shrink tube can comprise different materials or consist of different materials.

A preferred embodiment of the method is characterized in that the shrink tube comprises an elastomer or consists of an elastomer.

A preferred embodiment of the method is characterized in that the shrink tube comprises a polyurethane or, preferably, consists of a polyurethane.

A preferred embodiment of the method is characterized in that the shrink tube comprises a fluorinated polymer or, preferably, consists of a fluorinated polymer.

A preferred embodiment of the method is characterized in that the fluorinated polymer is an ethylene-tetrafluoroethylene copolymer (ETFE), a polytetrafluoroethylene (PTFE), a perfluoroalkoxy polymer (PFA), a polyvinylidene fluoride (PVDF) and/or a tetrafluoroethylene-hexafluoropropylene copolymer (FEP).

The temperature to which the shrink tube is heated in method step f) for radial contraction depends in particular on the material of the shrink tube used.

A preferred embodiment of the method is characterized in that the heating in method step f) takes place to a temperature range between 140° C. and 220° C., preferably between 160° C. and 210° C. This range ensures quick and even formation of the outer insulation.

The period during which the shrink tube is heated to a certain temperature in method step f) depends in particular on the material of the shrink tube used and on the temperature used. The period tends to decrease with increasing temperature. Preferably, the shrink tube is heated in the method step for a period of between 5 min and 15 min.

As already described, the inner lining has an inner lining length which corresponds to a multiple of the lead length.

A preferred embodiment of the method is characterized in that the inner lining length in method step a) is in a range between 50 m and 2,000 m. This allows the production of a multiple conductors, in particular different ones, in particular conductors of different lengths, with a single uninsulated cable.

The properties of the shrink tube, in particular its thickness, must be selected according to the specific application of the lead.

A preferred embodiment of the method is characterized in that the shrink tube in method step e) has a thickness in a range of 50 μm to 350 μm. This range allows the production of a conductor having sufficiently thick outer insulation, which provides good physical protection of the interior of the lead, in particular the electrically conductive channels, while at the same time keeping the outer diameter of the final lead as small as possible. It is advantageous for the lead to have the smallest possible outer diameter, since inserting the lead into the patient, in particular into his or her body vessels, is associated with negative effects on the body vessels as the outer diameter increases.

The dimensions, in particular the length, the outer diameter and the inner diameter, of the shrink tube to be used depend on the dimensions of the desired lead. For example, the shrink tube can be shorter, longer or the same as the lead length.

A preferred embodiment of the method is characterized in that the shrink tube in method step e) has a length which corresponds to 1.01 to 1.1 times the lead length. Such a long shrink tube compensates for axial shrinkage of the shrink tube during the production of the lead, so that the resulting outer insulation is also formed at the ends of the lead. Furthermore, a shrink tube which is longer than the lead length allows for easy and efficient closure of at least the distal end of the lead. The closure prevents the penetration of liquids, in particular body fluids, and the resulting short-circuiting of the electrically conductive channels.

A preferred embodiment of the method is characterized in that the shrink tube in method step e) has an inner diameter which corresponds to 1.01 to 1.1 times an outer diameter of the uninsulated lead cable. This allows the shrink tube to be easily pulled onto the uninsulated lead cable in method step e) and at the same time ensures that a uniform, in particular uniformly thick, outer insulation can be formed in method step f).

### BRIEF DESCRIPTION OF THE DRAWINGS

The invention is not limited to the figures. The invention is further illustrated by way of example below by means of figures:

FIG. 1 shows an exemplary flow chart of a method for producing a multipolar lead for a medical device; and,

FIGS. 2a-2f shows exemplary intermediate products of the method for producing a multipolar lead in a schematic cross section.

### DETAILED DESCRIPTION OF THE INVENTION

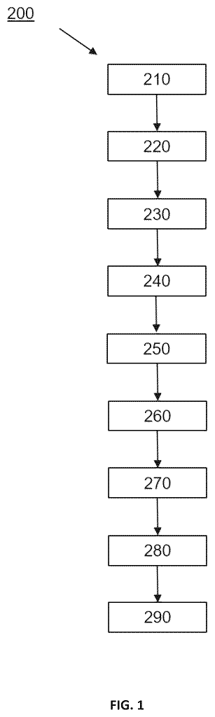

FIG. 1 shows a flow chart of an exemplary method for producing a multipolar lead. In a method step 210, a hollow-cylindrical inner lining is provided, having an inner lining length which corresponds to a multiple of a final lead length of the lead to be produced for the medical device.

In a method step 220, a plurality of electrically conductive channels are provided. Each of the channels comprises at least one insulated conductor comprising an electrical conductor and an insulating layer arranged around the electrical conductor.

In a method step 230, the plurality of electrically conductive channels are spirally wound around the inner lining provided in method step 210. Method step 230 thus provides an uninsulated cable, wherein a cable length of the uninsulated cable corresponds to a multiple of the lead length, in particular wherein the cable length corresponds to the inner lining length.

In a method step 240, the uninsulated cable obtained in method step 230 is cut to a length which corresponds to the lead length. Due to the cutting, a plurality of uninsulated lead cables are preferably obtained, wherein the uninsulated lead cables differ from the uninsulated cable substantially only in their length. The uninsulated lead cables thus obtained preferably have the same length.

In a method step 250, the uninsulated lead cable obtained in method step 240 is sheathed with a provided shrink tube. The length of the shrink tube is matched to the lead length. The sheathing is preferably carried out by pulling the shrink tube onto the uninsulated lead cable.

In a method step 260, the shrink tube used in method step 250 is heated in such a way that it contracts radially and thus forms an outer insulation for the uninsulated lead cable. In method step 260, an insulated lead cable is thus produced with the shrunk shrink tube as outer insulation.

In a method step 270, a plurality of electrodes are provided. Preferably, the electrodes are ring electrodes. The number of electrodes depend on the application of the lead to be produced. Preferably, the number of electrodes corresponds to a maximum of the number of electrically conductive channels used in the method.

In a method step 280, a plurality of contact openings are created near a distal end of the insulated lead cable. The contact openings serve to electrically contact the electrodes with the electrically conductive channels. For this purpose, a part of the outer insulation and a part of the insulating layer of at least one electrically conductive channel are removed at each of the contact openings, so that an electrode can be selectively electrically contacted with the corresponding electrical conductor of the electrically conductive channel via the contact opening. Exactly one or more than one, for example two or three, electrically conductive channels can be electrically connected to an electrode via a contact opening. Preferably, the number of contact openings corresponds to the number of electrodes, so that one electrode can be electrically contacted via each contact opening.

For example, the contact openings can be created by laser ablation.

In a method step 290, the plurality of electrodes are electrically contacted with the plurality of electrically conductive channels via the contact openings. Each of the electrodes is selectively electrically contacted via one of the contact openings with one or more electrically conductive channels which are accessible via the relevant contact opening.

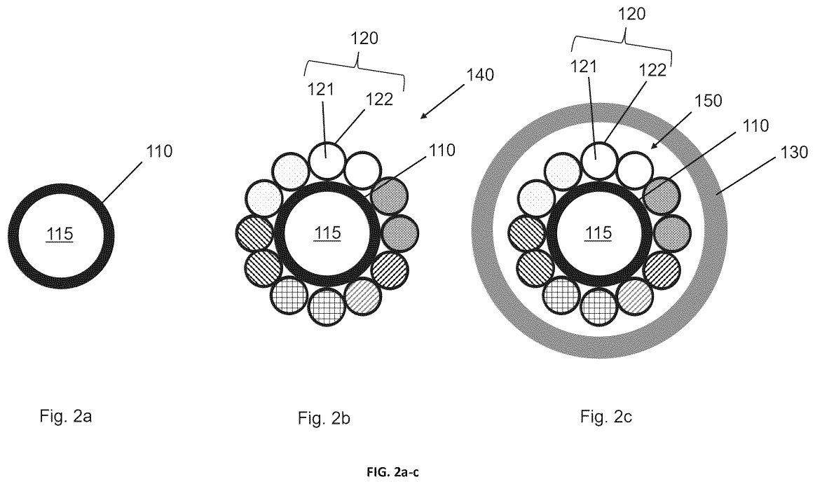

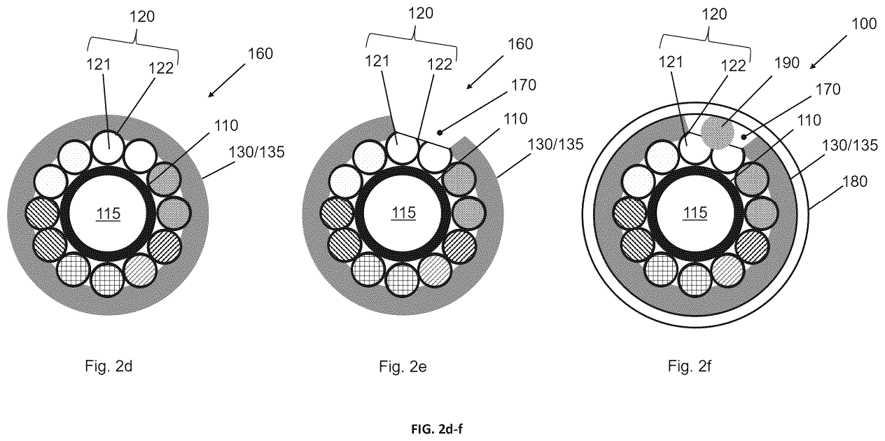

FIG. 2 show various exemplary intermediate products of the method 200 shown in FIG. 1 for producing a bi- or multipolar lead in a schematic cross section.

FIG. 2a shows a hollow-cylindrical inner lining 110. The inner lining 110 encloses an inner lumen 115 and has an inner lining length which corresponds to a multiple of a lead length of the final produced lead (not visible in the cross section).

FIG. 2b shows an uninsulated cable 140 comprising the inner lining 110 from FIG. 2a and a total of twelve conductive channels 120 (provided with reference signs only as an example), wherein the twelve conductive channels 120, which were previously provided, were wound spirally around the inner lining 110. In the embodiment shown, each of the electrically conductive channels 120 comprises exactly one insulated conductor which comprises an electrical conductor 121 with an insulating layer 122 surrounding the electrical conductor 121. The electrically conductive channels 120 are each shown in adjacent groups of two with different hatching, which is only intended to provide a better overview of the intermediate products shown. Otherwise, the electrically conductive channels 120 do not differ from each other. The electrically conductive channels 120 are wound spirally (not visible in the cross section) and adjacently to one another along the entire inner lining length 110.

FIG. 2c shows an uninsulated lead cable 150 obtained by cutting the uninsulated cable 140 from FIG. 2b and sheathed by a shrink tube 130 by pulling it on. The cutting was done to the desired lead length (not visible in the cross section) which the final produced lead should have. The inner diameter of the shrink tube 130 is larger than the outer diameter of the uninsulated lead cable 150, which simplifies sheathing (difference in diameter exaggerated for better illustration).

FIG. 2d shows an insulated lead cable 160 produced by heating the uninsulated lead cable 150 sheathed with the shrink tube 130. Due to the heating, the shrink tube 130 has contracted radially and the shrunk shrink tube 130 forms an outer insulation 135 of the insulated cable 160. In addition, the outer insulation 135 fixes the electrically conductive channels 120 wound around the inner lining 110.

FIG. 2e shows the insulated lead cable 160 from FIG. 2d, wherein, in contrast to FIG. 2d, the insulated lead cable 160 comprises a contact opening 170 near a distal end (not visible in the cross section). The contact opening 170 was created by removing parts of the outer insulation 135 and parts of the insulating layer 122 of two adjacent electrically conductive channels 120. By removing these electrically insulating components, selective electrical contacting of the electrical conductors 121 of the corresponding electrically conductive channels 120 from outside the insulated lead cable is possible. In the embodiment shown, a contact opening comprises exposing two adjacent electrical conductors 121 so that they can be electrically contacted with a single electrode. This increases the reliability of the final conductor in the event of a failure, for example due to severing, of one of the electrical conductors 121, in particular due to kinking. In this case, a current flow would still be possible via the second electrically conductive channel 120.

FIG. 2f shows the final lead 100 produced using the method 200. Starting from the intermediate product of FIG. 2e, the two adjacent electrically conductive channels 120, in particular their electrical conductor 121, were electrically contacted with an electrode 180 in the form of a ring electrode. In the embodiment shown, this was not done by direct but rather by indirect electrical contact via a bridge element 190 in the form of an electrically conductive wire portion. The bridge element 190 serves in particular to bridge the distance between the electrical conductors 121 and the electrode 180, which is mainly caused by the radial thickness of the outer insulation 135. The lead 100 comprises a total of six electrodes 180, each of which selectively electrically contacts two adjacent electrically conductive channels 120 via a total of six contact openings 170, wherein only one electrode 180 including the contact point is visible in the cross section shown. Each of the electrically conductive channels 120 is electrically connected only to a single electrode 180 indirectly via a bridge element 190.

The features disclosed in the claims, the description and the drawings may be essential for various embodiments of the claimed invention both individually and in any combination with one another.

### REFERENCE NUMERALS

100 lead
110 inner lining
115 inner lumen
120 electrically conductive channel
121 electrical conductor
122 insulating layer
130 shrink tube
135 outer insulation
140 uninsulated cable
150 uninsulated lead cable
160 insulated lead cable
170 contact opening
180 electrode
190 bridge element
200 method
210 provision of inner lining
220 provision of electrically conductive channels
230 winding
240 cutting
250 sheathing
260 heating
270 provision of electrodes
280 creation of contact openings
290 contacting

What is claimed is:

1. A method for producing a bi- or multipolar lead for a medical device, comprising the method steps of:
a) providing a hollow-cylindrical inner lining having an inner lining length which corresponds to a multiple of a lead length of the lead for the medical device;
b) providing a plurality of electrically conductive channels, wherein each of the channels is formed by at least one insulated conductor comprising an electrical conductor and an insulating layer;
c) spirally winding the electrically conductive channels around the inner lining to provide an uninsulated cable having a cable length which corresponds to a multiple of the lead length;
d) cutting the uninsulated cable to a length which corresponds to the lead length, to provide an uninsulated lead cable;
e) sheathing the uninsulated lead cable with a shrink tube;
f) heating the shrink tube to provide an insulated lead cable having the shrunk shrink tube as an outer insulation;
g) providing a plurality of electrodes;
h) creating a plurality of contact openings near a distal end of the insulated lead cable, wherein, in order to create a contact opening, parts of the outer insulation and parts of the insulating layer of at least one of the electrically conductive channels are removed so that the at least one electrically conductive channel can be selectively contacted via each of the contact openings;
i) electrically contacting the plurality of electrodes with the plurality of electrically conductive channels via the plurality of contact openings, wherein each of the electrodes is selectively electrically connected to at least one of the electrically conductive channels via one of the contact openings.

2. The method according to claim 1, wherein the hollow-cylindrical inner lining comprises a polymer hose, a metal tube and/or a metal braid or consists of a polymer hose, a metal tube or a metal braid.

3. The method according to claim 1, wherein the provision in method step a) comprises pulling the inner lining onto a mandrel.

4. The method according to claim 1, wherein the shrink tube comprises an elastomer or consists of an elastomer.

5. The method according to claim 1, wherein the shrink tube comprises a fluorinated polymer or consists of a fluorinated polymer.

6. The method according to claim 5, wherein the fluorinated polymer is an ethylene-tetrafluoroethylene copolymer (ETFE), a polytetrafluoroethylene (PTFE), a perfluoroalkoxy polymer (PFA), a polyvinylidene fluoride (PVDF) and/or a tetrafluoroethylene-hexafluoropropylene copolymer (FEP).

7. The method according to claim 1, wherein the heating in method step f) is carried out to a temperature range between 140° C. and 220° C.

8. The method according to claim 1, wherein the inner lining length in method step a) is in a range between 50 m and 2,000 m.

9. The method according to claim 1, wherein in method step i) the electrical contacting takes place via a bridge element.

10. The method according to claim 1, wherein the shrink tube in method step e) has a thickness in a range of 50 μm to 350 μm.

11. The method according to claim 1, wherein the shrink tube in method step e) has a length which corresponds to 1.01 to 1.1 times the lead length.

12. The method according to claim 1, wherein the shrink tube in method step e) has an inner diameter which corresponds to 1.01 to 1.1 times an outer diameter of the uninsulated lead cable.

13. The method according to claim 2, wherein the provision in method step a) comprises pulling the inner lining onto a mandrel.
